(19) United States
(12) Patent Application Publication
(10) Pub. No.: US 2025/0355651 A1
(43) Pub. Date: Nov. 20, 2025

(54) COMMAND PROCESSING METHOD AND COMMAND PROCESSING DEVICE

(71) Applicant: Shanghai Zhaoxin Semiconductor Co., Ltd., Shanghai (CN)

(72) Inventors: Mengchen YANG, Beijing (CN); Qiuping SUN, Beijing (CN); Yitong LIU, Beijing (CN)

(21) Appl. No.: 18/964,339

(22) Filed: Nov. 29, 2024

(30) Foreign Application Priority Data
May 16, 2024 (CN) 202410614068.2

(51) Int. Cl. G06F 8/41

(52) U.S. Cl. CPC G06F 8/4435

(57) ABSTRACT

The present disclosure relates to a command processing method and device. The command processing method includes a determination step and a processing step. In the determination step, when running a program, a determination is made as to whether a loop of the program running satisfies a predetermined condition for executing a process to eliminate a redundant memory access instruction. In the processing step, when it is determined that the loop of the program running satisfies the predetermined condition, the redundant memory access instruction in the loop is executed by the elimination process.

### CROSS REFERENCE TO RELATED APPLICATIONS

This application claims priority of China Patent Application No. 202410614068.2, filed on May 16, 2024, the entirety of which is incorporated by reference herein.

### BACKGROUND

### Technical Field

The present application relates in general to the field of command processing technology, and in particular it relates to a command processing method and a command processing device.

### Description of the Related Art

A compiler can compile the source code of a computer program to convert that source code into assembly language instructions or machine code instructions, and the compiler can run the instructions. However, the program may have redundant memory access instructions.

In related technologies, a compiler can optimize and delete redundant memory access instructions by performing a static analysis on program code. However, static analysis is not accurate enough. Optimization of redundant memory access instructions needs to be improved.

### BRIEF SUMMARY

The present disclosure provides a command processing method, a command processing device, a compiler, a storage media, and a computer program product. This can more fully optimize redundant memory access instructions, thereby reducing the program's access to memory and improve program execution efficiency.

According to a first aspect of the present disclosure, a command processing method is provided. The command processing method includes executing a determination step, wherein when running a program, a determination is made as to whether a loop of the program running satisfies a predetermined condition for executing an elimination process on a redundant memory access instruction. The command processing method includes executing a processing step, wherein when it is determined that the loop of the program running satisfies the predetermined condition, the redundant memory access instruction in the loop is executed by the elimination process.

In one possible implementation, the predetermined condition includes a set of pointers to be tested that were created for the loop of the program to record the pointer pair that have alias relationships not being empty. The step of executing the determination step correspondingly includes the following steps. When the program is running, a determination is made as to whether the set of pointers to be tested that were created for the loop of the program running is empty. The step of executing the processing step correspondingly includes the following steps. When the set of pointers to be tested that were created for the loop of the program is not empty, the step includes executing the elimination process on the loop.

In one possible implementation, in response to determining that the set of pointers to be tested that were created for the loop of the program is not empty and executing the elimination process on the loop includes the following steps. When the set of pointers to be tested that were created for the loop of the program is not empty, the step includes determining whether the memory access instruction corresponding to the pointer pair has the redundant memory access instruction according to an instruction address corresponding to the pointer pair in the set of pointers to be tested. When it is determined that the memory access instruction corresponding to the pointer pair has the redundant memory access instruction, the step includes deleting the redundant memory access instruction.

In one possible implementation, the step of determining whether the memory access instruction corresponding to the pointer pair has the redundant memory access instruction according to the instruction address corresponding to the pointer pair in the set of pointers to be tested includes the following steps. A determination is made as to whether the instruction addresses corresponding to the pointer pair in the set of pointers to be tested are equal. When it is determined that the instruction addresses corresponding to the pointer pair in the set of pointers to be tested are not equal, it is determined that the memory access instruction corresponding to the pointer pair has the redundant memory access instruction.

In one possible implementation, the command processing method further includes the following steps. When it is determined that the instruction addresses corresponding to the pointer pair in the set of pointers to be tested are equal, then it is determined that the memory access instruction corresponding to the pointer pair does not has the redundant memory access instruction. Then, the memory access instruction corresponding to the pointer pair is run and the elimination process is not executed on the memory access instruction.

In one possible implementation, in response to determining that the set of pointers to be tested that were created for the loop of the program is empty and executing the elimination process on the loop includes the following steps. When the set of pointers to be tested that were created for the loop of the program is not empty, the step includes determining whether the memory access instruction corresponding to the pointer pair has the redundant memory access instruction according to an instruction address corresponding to the pointer pair in the set of pointers to be tested. When it is determined that the memory access instruction corresponding to the pointer pair has the redundant memory access instruction, the step includes counting the number of redundant memory access instructions and determining whether the elimination process on the loop has been executed according to the number of redundant memory access instructions in the loop.

In one possible implementation, the step of determining whether the elimination process on the loop is executed according to the number of redundant memory access instructions in the loop includes the following steps. The step includes calculating the ratio of the number of redundant memory access instructions in the loop to the total number of memory access instructions in the loop. When the ratio is greater than or equal to a threshold, the step includes executing the elimination process on the loop to delete all redundant memory access instructions in the loop.

In one possible implementation, when the ratio is less than the threshold, the elimination process is not executed on the loop. Optionally, all redundant memory access instructions are retained in the loop. In one possible implementation, when the ratio is less than the threshold, other elimination processing is executed in the loop. The present disclosure is not limit to this.

In one possible implementation, the step of determining whether the memory access instruction corresponding to the pointer pair has the redundant memory access instruction according to the instruction address corresponding to the pointer pair in the set of pointers to be tested includes the following steps. The step includes determining whether the instruction addresses corresponding to the pointer pair in the set of pointers to be tested are equal. When it is determined that the instruction addresses corresponding to the pointer pair in the set of pointers to be tested are not equal, the step includes determining that the memory access instruction corresponding to the pointer pair has the redundant memory access instruction.

In one possible implementation, the command processing method further includes the following steps. When it is determined that the loop of the program running does not satisfy the predetermined condition, the command processing method further includes running the loop and executing the step of executing the determination step and the step of executing the processing step again for the loop until the loop is executed a predetermined number of times.

In one possible implementation, the command processing method further includes the following steps. When it is determined that the loop of the program running does not satisfy the predetermined condition, the command processing method further includes running the loop and executing the step of executing the determination step and the step of executing the processing step sequentially for another loop of the program running.

In one possible implementation, before the step of executing the determination step, the step of using the command processing method further includes creating a set of pointers to be tested for the loop of the program.

In one possible implementation, the step of creating a set of pointers to be tested for the loop of the program includes traversing instructions in reverse order in a basic block in the loop for the loop of the program. The step also includes determining whether a first memory access instruction with the same address has been accessed before. When it is determined that the first memory access instruction with the same address has been accessed before and it cannot be determined whether an address of the second memory access instruction corresponding to the first memory access instruction between two of the first memory access instructions is the same address, the step includes recording the address of the first memory access instruction and the address of the second memory access instruction into the set of pointers to be tested.

In one possible implementation, the redundant memory access instruction includes at least one of a read instruction and a write instruction.

According to a second aspect of the present disclosure, a command processing device is provided. The command processing device includes a determination module and a processing module. The determination module is configured to determine whether a loop of the program running satisfies a predetermined condition for executing a process to eliminate a redundant memory access instruction. When the processing module determines that the loop of the program running satisfies the predetermined condition, the elimination process is performed on the redundant memory access instruction in the loop.

In one possible implementation, the predetermined condition includes a set of pointers to be tested that were created for the loop of the program to record the pointer pair that have alias relationships not being empty. Correspondingly, the determination module is configured to determine whether the set of pointers to be tested that were created for the loop of the program running is empty when the program is running. The processing module is configured to execute the elimination process on the loop when the set of pointers to be tested that were created for the loop of the program is not empty.

In one possible implementation, the processing module is configured to make a determination as to whether the set of pointers to be tested that were created for the loop of the program is not empty, and to make a determination as to whether the memory access instruction corresponding to the pointer pair has the redundant memory access instruction according to an instruction address corresponding to the pointer pair in the set of pointers to be tested. When it is determined that the memory access instruction corresponding to the pointer pair has the redundant memory access instruction, the redundant memory access instruction is deleted.

In one possible implementation, the processing module is configured to: determine whether the instruction addresses corresponding to the pointer pair in the set of pointers to be tested are equal; and when it is determined that the instruction addresses corresponding to the pointer pair in the set of pointers to be tested are not equal, determine the memory access instruction corresponding to the pointer pair has the redundant memory access instruction.

In one possible implementation, the processing module is configured to make a determination as to whether the instruction addresses corresponding to the pointer pair in the set of pointers to be tested are equal, determine the memory access instruction corresponding to the pointer pair does not has the redundant memory access instruction; and run the memory access instruction corresponding to the pointer pair and not execute the elimination process to the memory access instruction.

In one possible implementation, the processing module is configured to make a determination as to whether the set of pointers to be tested that were created for the loop of the program is not empty, and if so, it determines whether the memory access instruction corresponding to the pointer pair has the redundant memory access instruction according to an instruction address corresponding to the pointer pair in the set of pointers to be tested. When it is determined that the memory access instruction corresponding to the pointer pair has the redundant memory access instruction, it counts the number of redundant memory access instructions and determines whether the elimination process on the loop has been executed according to the number of redundant memory access instructions in the loop.

In one possible implementation, the processing module is configured to calculate the ratio of the number of redundant memory access instructions in the loop to the total number of memory access instructions in the loop. When the ratio is greater than or equal to a threshold, the step includes executing the elimination process on the loop to delete all redundant memory access instructions in the loop. Optionally, the threshold is a preset fixed value. For example, the threshold may be 10%. Optionally, the threshold may be dynamically adjusted.

In one possible implementation, the processing module is configured to make a determination as to whether the ratio is less than the threshold, and if so, the elimination process is not executed on the loop. Optionally, it retains all redundant memory access instructions in the loop. In one possible implementation, when the ratio is less than the threshold, the processing module is configured to perform other elimination processing on the loop.

In one possible implementation, when it is determined that the loop of the program running does not satisfy the predetermined condition, run the loop and executing the step of executing the determination step and the step of executing the processing step again for the loop until the loop is executed a predetermined number of times.

In one possible implementation, when it is determined that the loop of the program running does not satisfy the predetermined condition, run the loop and execute the step of executing the determination step and the step of executing the processing step sequentially for another loop of the program running.

In one possible implementation, the command processing device further includes a creating module. The creating module is configured to create a set of pointers to be tested for the loop of the program.

In one possible implementation, the creating module is configured to traverse instructions in reverse order in a basic block in the loop for the loop of the program. The creating module is configured to determine whether a first memory access instruction with the same address has been accessed before. When it is determined that the first memory access instruction with the same address has been accessed before and it cannot be determined whether an address of the second memory access instruction corresponding to the first memory access instruction between two of the first memory access instructions is the same address, the creating module is configured to record the address of the first memory access instruction and the address of the second memory access instruction into the set of pointers to be tested.

According to a third aspect of the present disclosure, a command processing device is provided. The command processing device includes the processor and the memory. The memory is configured to store a plurality of instructions, wherein the instructions are executed by the processor. The command processing method described in the first aspect of the present disclosure is implemented when the processor is configured to execute the instructions stored in the memory.

According to a four aspect of the present disclosure, a compiler is provided. The compiler including the command processing device described in the second aspect or the third aspect.

According to a five aspect of the present disclosure, a non-volatile computer readable storage media is provided. The non-volatile computer readable storage media stores computer program instructions. When the computer program instructions are executed by the processor, the command processing method described in the first aspect is implemented.

According to a six aspect of the present disclosure, a computer program product is provided. The computer program product includes computer program instructions. The computer program instructions implement the command processing method described in the first aspect when run by one or more processors.

According to the command processing method, the command processing device, the compiler, the non-volatile computer readable storage media, and the computer program product of the present disclosure, the compiler determines whether the loop of the program running satisfies the predetermined condition for executing the process for eliminating the redundant memory access instruction when the compiler runs the program. When it is determined that the loop of the program running satisfies the predetermined condition, the redundant memory access instruction in the loop is executed by the elimination process. Therefore, compared with the prior art that performs the static analysis during the compilation of the program code to optimize and delete the redundant memory access instructions, the present disclosure performs the dynamic analysis during the running of program code. The redundant memory access instructions may be more fully optimized. It enhances the optimization capabilities of the compiler, it eliminates the redundant memory access instructions (such as write instructions and read instructions) in the program, it reduces the program's access to memory, and it improves the execution efficiency of the program.

Other features and aspects of the present disclosure will become apparent from the following detailed description of exemplary embodiments with reference to the accompanying drawings.

### BRIEF DESCRIPTION OF THE DRAWINGS

The present application can be more fully understood by reading the subsequent detailed description and examples with references made to the accompanying drawings, wherein:

FIG. 1 is a flow chart of a command processing method according to one embodiment of the present disclosure.

FIG. 2 is a flow chart of a command processing method according to one embodiment of the present disclosure.

FIG. 3 is a flow chart of a command processing method according to one embodiment of the present disclosure.

FIG. 4 is a flow chart of step S320 in FIG. 3 according to one embodiment of the present disclosure.

FIGS. 5A-5C are flow charts of a command processing method according to one embodiment of the present disclosure.

FIG. 6 is a block diagram of a command processing method according to one embodiment of the present disclosure.

FIG. 7 is a block diagram of a command processing device 1900 according to one embodiment of the present disclosure.

### DETAILED DESCRIPTION

The following description is made for the purpose of illustrating the general principles of the application and should not be taken in a limiting sense. The scope of the application is best determined by reference to the appended claims.

Various exemplary embodiments, features, and aspects of the present disclosure will be described in detail below with reference to the accompanying drawings. The same reference numbers in the drawings identify functionally identical or similar elements. Although various aspects of the embodiments are illustrated in the drawings, the drawings are not necessarily drawn to scale unless otherwise specified.

The word “exemplary” as used herein means “serving as an example, example, or illustrative.” Any embodiment described herein as “exemplary” is not necessarily to be construed as superior or superior to other embodiments.

In addition, in order to better explain the present disclosure, numerous specific details are provided in the following specific embodiments. It will be understood by those skilled in the art that the present disclosure may be practiced without certain specific details. In some instances, methods, means, components and circuits that are well known to those skilled in the art are not described in detail in order to highlight the gist of the disclosure.

As described above, the redundant memory access instructions may exist in the program. Correspondingly, redundant memory access instructions may be deleted through compilation optimization. In related technology, the statements in the basic block of the program are traversed. When there are two store instructions pointing to the same address, it is determined whether there is a load instruction to the same address between the two store instructions. When there is no load instruction between the two store instructions (that is, when there is a load instruction, and it may be determined based on the results of static analysis that the addresses accessed by the load instruction and the store instruction must be different), the previous store instruction may be deleted, otherwise it will not do any processing.

Therefore, the compiler needs to determine whether the addresses accessed by the load instruction and the store instruction are the same based on the results of static analysis. When it cannot be determined whether the addresses accessed by the two are the same, optimization of redundant memory access instructions cannot be performed.

In other words, current compilers mainly optimize redundant memory access instructions through static analysis. Specifically, the alias information of the pointer is obtained through static analysis of the program code during compilation. When eliminating redundant write instructions, it is necessary to judge whether the pointer addresses are equal based on the results of static analysis, and decide whether to optimize the redundant memory access instructions based on the judgment results.

Therefore, compilers in the prior art perform static analysis at compile time to optimize redundant memory access instructions. Although it will not introduce additional overhead and lead to possible negative optimization, many optimization opportunities will be missed due to insufficient static analysis. The optimization of redundant memory access instructions needs to be improved.

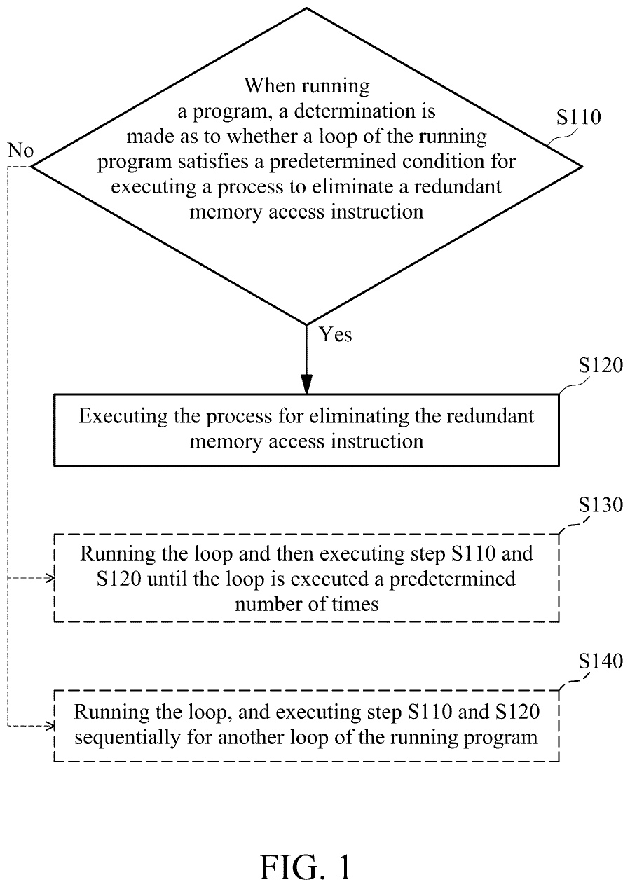

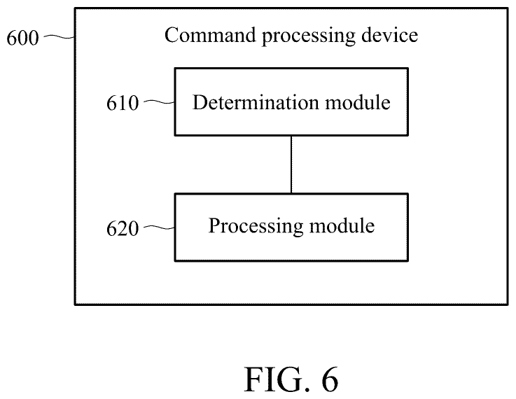

For this reason, the present disclosure proposes the command processing method shown in FIG. 1 and the command processing device shown in FIG. 6.

FIG. 1 is a flow chart of a command processing method according to one embodiment of the present disclosure. In one possible implementation, the command processing method may be applied to the compiler. In other words, the command processing method may be executed by the compiler. Of course, it should be understood that the command processing method may also be executed by other devices. For the convenience of description, the following will take the compiler as an example. As shown in FIG. 1, the command processing method may include the following steps:

Step S110 (the determination step) involves the following: when running a program, a determination is made as to whether a loop of the program running satisfies a predetermined condition for executing a process to eliminate a redundant memory access instruction.

The prior art optimizes redundant memory access instructions when the compiler compiles the program. The present disclosure executes the command processing method not while the compiler is compiling the program but while the compiler runs the program. In one possible implementation, the compiler may execute the command processing method multiple times on a certain loop included in the program running during the running of the program. Of course, the compiler may also execute the command processing method sequentially on a plurality of loops included in the program running.

Each of the loops include a plurality of basic blocks. There may be repeated memory access instructions to the same address in the basic block within the loop, such as a read instruction or a write instruction. For such memory access instructions, it may not be possible to determine whether they are redundant based on the results of the static analysis during the program compilation, so the redundancy of such memory access instructions cannot be eliminated. However, the command processing method of the present disclosure may determine whether the loop of the program running satisfies the predetermined condition when running the program, and the command processing method may determine whether the redundant memory access instruction is existed according to a judgment result to further determine whether the loop is executed by the elimination process.

When it is determined that the loop of the program running satisfies the predetermined condition, it means that the redundant memory access instruction is existed in the loop. Accordingly, the redundant memory access instruction needs to execute the elimination process, and the subsequent step S120 may be executed.

In one possible implementation, when it is determined that the loop of the program running not satisfies the predetermined condition, it means that the redundant memory access instruction is not existed in the loop. Accordingly, the redundant memory access instruction do not need to execute the elimination process, and the subsequent step S130 may be executed.

In another possible implementation, when it is determined that the loop of the program running not satisfies the predetermined condition, it means that the redundant memory access instruction is not existed in the loop. Accordingly, the redundant memory access instruction do not need to execute the elimination process, and the subsequent step S140 may be executed.

The step S120 (a determination step), the process for eliminating the redundant memory access instruction is executed.

In this embodiment, in response to determine that the loop of the program running satisfies the predetermined condition, the redundant memory access instruction in the loop is executed by the elimination process.

Step S130 involves running the loop and then executing steps S110 and S120 until the loop is executed a predetermined number of times.

In this embodiment, in response to determining that the loop of the program running does not meet the predetermined condition, there is no need to perform the elimination process on the loop, and the loop may be run. After the loop is executed, the number of executions of the loop may be increased by 1. During the next run of the loop, steps S110 and S120 may be executed again. When there is still no need to eliminate the loop, the loop is still run. After the loop is executed, the number of executions of the loop may be increased by 1 again, . . . , and so on until the number of executions of the loop reaches the predetermined number of times. For example, the predetermined number of times may be 16.

Therefore, it is possible to avoid a decrease in execution efficiency of the program due to excessive execution of the command processing method for the loop.

Step S140 involves running the loop, and executing steps S110 and S120 sequentially for another loop of the program running.

In this embodiment, in response to determining that the loop of the program running does not meet the predetermined condition, there is no need to perform the elimination process on the loop, and the loop may be run. After executing the loop, steps S110 and S120 may be executed for another loop of the program. When there is still no need to perform the elimination process for the other loop, the other loop is run. After the other loop is executed, steps S110 and S120 may be executed for the other loop of the program, . . . , and so on until steps S110 and S120 are executed for all loops of the program.

Therefore, the program running may be more comprehensively eliminated from the redundant memory access instructions.

According to this embodiment, when the compiler runs the program, it determine whether the loop of the program running satisfies the predetermined condition for executing the process for eliminating the redundant memory access instruction. When it is determined that the loop of the program running satisfies the predetermined condition, the redundant memory access instruction in the loop is executed by the elimination process. Therefore, compared with the prior art of performing the static analysis during the compilation of the program code to optimize and delete the redundant memory access instructions, the present disclosure performs the dynamic analysis during the program code is run. Accordingly, the redundant memory access instructions may be more fully optimized, the optimization capability of the compiler is enhanced, the redundant memory access instructions (such as write instructions and read instructions) in the program are eliminated, the program's access to memory is reduced, and it improves program execution efficiency.

In other words, this embodiment may use the method determined when running the program to make up for the lack of static analysis capabilities of the compiler, thereby enhancing the effect of eliminating redundant memory access instructions. It may the program's access to the memory, thereby improving the execution efficiency of the program.

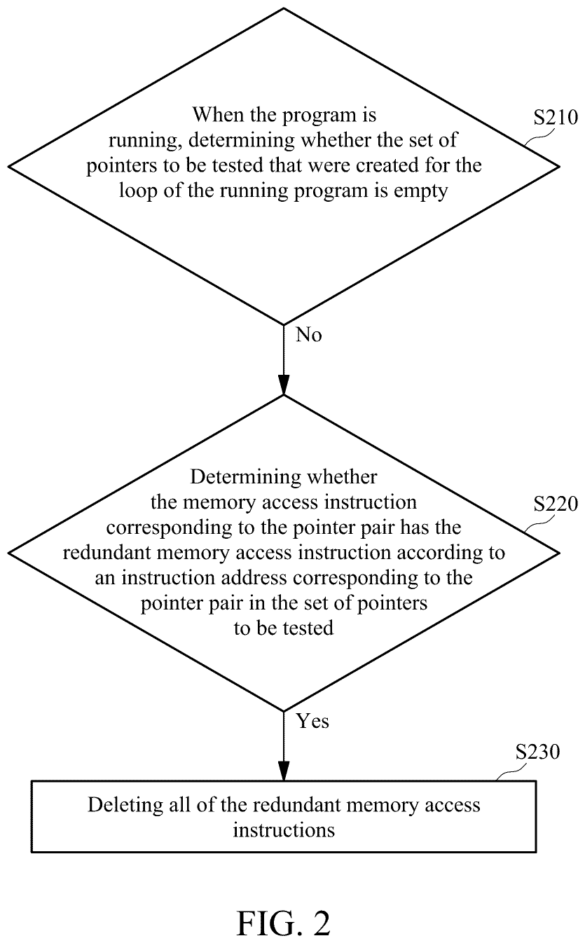

FIG. 2 is a flow chart of a command processing method according to one embodiment of the present disclosure, in one possible implementation, the command processing method may be applied to the compiler. In other words, the command processing method may be executed by the compiler. Of course, it should be understood that the command processing method may also be executed by other devices. For the convenience of description, the following will take the compiler as an example. As shown in FIG. 2, the command processing method may include the following steps:

Step S210 involves, when the program is running, determining whether the set of pointers to be tested that were created for the loop of the program running is empty.

In this embodiment, the predetermined condition may include a set of pointers to be tested that were created for the loop of the program to record the pointer pair that have alias relationships not being empty. In other words, whether or not the set of pointers to be tested is empty is the trigger condition for executing elimination process on the loop. The set of pointers to be tested records pointer pairs that have an alias relationship. A pointer pair with an alias relationship refers to two pointers pointing to the same address in the same memory.

In one possible implementation, the set of pointers to be tested may be created in the following manner for the loop of the program: for a loop in the program, traversing the statements in the loop in reverse order for each basic block in the loop; for each statement, determining whether the first memory access instruction with the same address has been accessed before; when it is determined that the first memory access instruction has been accessed before, and it cannot be determined whether the address of the second memory access instruction corresponding to the first memory access instruction between the two first memory access instructions is the same address, then recording the address of the first memory access instruction and the address of the second memory access instruction into the set of pointers to be tested.

When it is determined that the set of pointers to be tested and created for the loop of the program is empty, it means that there is no pointer pair with an alias relationship in the loop. There may be no redundant memory access instructions in the loop, and steps S130 or S140 may be performed. Regarding step S130 or S140, please refer to the previous description of FIG. 1 for the details, and it will not be described again here.

When it is determined that the set of pointers to be tested and created for the loop of the program is not empty, it means that there is a pointer pair with an alias relationship in the loop. There may be the redundant memory access instructions in the loop, and step S120 may be performed. Regarding step S120, please refer to the previous description of FIG. 1 for the details, and it will not be described again here. Of course, when it is determined that the set of pointers to be tested and created for the loop of the program is not empty, the subsequent step S220 may also be performed.

Step S220 involves determining whether the memory access instruction corresponding to the pointer pair has the redundant memory access instruction according to an instruction address corresponding to the pointer pair in the set of pointers to be tested.

In one possible implementation, it may be determined whether the pointer pair in the set of pointers to be tested are equal to the corresponding instruction addresses of the pointer pair. When the corresponding instruction addresses of the pointer pair are not equal, it is determined that there are redundant memory access instructions in the memory access instructions corresponding to the pointer pairs, and the subsequent step S230 may be performed. When the instruction addresses corresponding to the pointer pairs are equal, it is determined that there are no redundant memory access instructions in the memory access instructions corresponding to the pointer pairs. Therefore, the memory access instruction corresponding to the pointer may be executed, the elimination process is not performed on the memory access instruction, and step S130 or S140 may be executed.

Step S230 involves deleting all of the redundant memory access instructions.

According to this embodiment, when the compiler runs the program, it determines whether the set of pointers to be tested and created for the loop of the program running is empty. When it is determined that it is not empty, the elimination process is performed on the loop to eliminate the redundant memory access instructions. Therefore, compared with the prior art of performing the static analysis during the compilation of program code to optimize and delete the redundant memory access instructions, the present disclosure performs the dynamic analysis of the alias relationships based on the set of pointers to be tested during the program code is run. Accordingly, the redundant memory access instructions may be more fully optimized, the optimization capability of the compiler is enhanced, the redundant memory access instructions (such as write instructions and read instructions) in the program are eliminated, the program's access to memory is reduced, and the program's execution efficiency is improved.

Furthermore, for the loop that cannot be processed by the static analysis, this embodiment may determine whether the instruction addresses corresponding to the pointer pair in the set of pointers to be tested are equal when the program is run. When they are not equal, the elimination process may be performed, thereby eliminating (deleting) more the redundant memory access instructions than the existing technology, further reducing the program's access to the memory, and further improving the execution efficiency of the program.

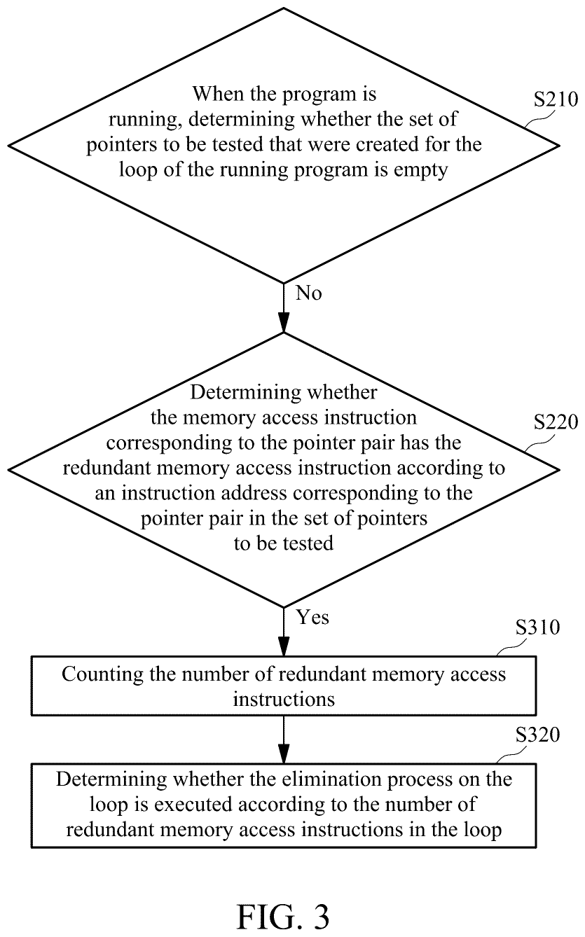

FIG. 3 is a flow chart of a command processing method according to one embodiment of the present disclosure. In one possible implementation, the command processing method may be applied to the compiler. In other words, the command processing method may be executed by the compiler. Of course, it should be understood that the command processing method may also be executed by other devices. For a convenience of description, the following will take the compiler as an example. As shown in FIG. 3, the command processing method may include the following steps:

Step S210 involves, when the program is running, determining whether the set of pointers to be tested that were created for the loop of the program running is empty.

When the set of pointers to be tested that were created for the loop of the program is not empty, the subsequent step S220 is executed. For step S210, please refer to the previous description of this step in FIG. 2; it is not repeated here.

Step S220 involves determining whether the memory access instruction corresponding to the pointer pair has the redundant memory access instruction according to an instruction address corresponding to the pointer pair in the set of pointers to be tested.

When it is determined that the memory access instruction corresponding to the pointer pair has the redundant memory access instruction, the subsequent step S310 is executed. For step S220, please refer to the previous description of this step in FIG. 2; it is not repeated here.

Step S310 involves counting the number of redundant memory access instructions.

Step S320 involves determining whether the elimination process on the loop is executed according to the number of redundant memory access instructions in the loop.

In this embodiment, when the set of pointers to be tested and created for the loop of the program running is not empty and it is determined that there are the redundant memory access instructions in the memory access instructions corresponding to the pointer pair in the set, the redundant access instructions in the loop are not immediately executed, and a count value of the redundant memory access instructions in the loop is counted. It is determined whether to perform the elimination process on the redundant memory access instructions in the loop according to the count value (that is, the number of redundant memory access instructions in the loop).

Thus, the process for eliminating the redundant memory access instructions in the loop may be performed in accordance with the number of redundant memory access instructions in the loop.

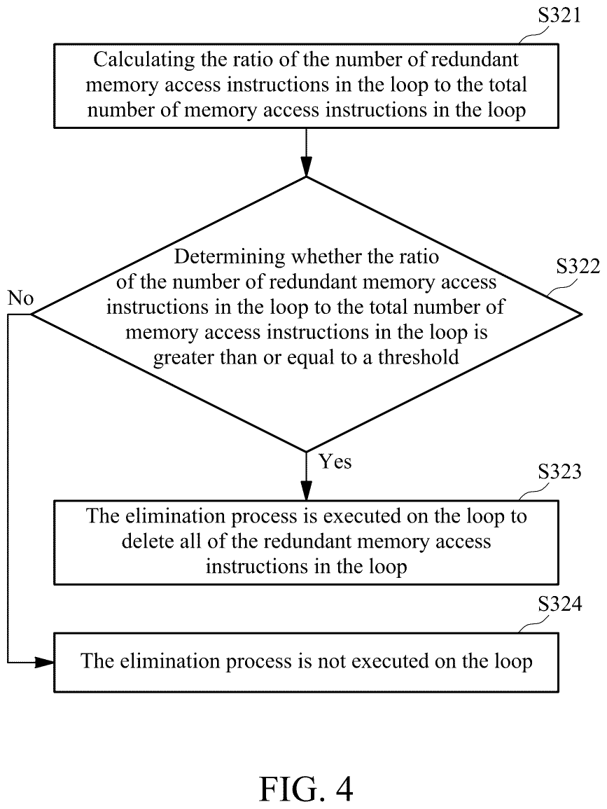

In one possible implementation, as shown in FIG. 4, step S320 may include the following steps:

Step S321 involves calculating the ratio of the number of redundant memory access instructions in the loop to the total number of memory access instructions in the loop.

Step S322 involves determining whether the ratio of the number of redundant memory access instructions in the loop to the total number of memory access instructions in the loop is greater than or equal to a threshold. Optionally, the threshold is a preset fixed value. For example, the threshold may be 10%. Optionally, the threshold may be adjusted dynamically.

When it is determined that the ratio is less than the threshold, it means that the proportion of the redundant memory access instructions in the loop is relatively small. Even when the redundant memory access instructions are eliminated for the loop, it may not bring the significant optimization improvements. Accordingly, there is no need to eliminate the redundant memory access instructions with the small proportion in the loop, and the subsequent step S324 may be performed.

When it is determined that the ratio is greater than or equal to the threshold, it means that the proportion of redundant memory access instructions in the loop is relatively large. The significant optimization improvements may be achieved by eliminating the redundant memory access instructions for the loop. Accordingly, the redundant memory access instructions that account for the large proportion in the loop may be eliminated, and the subsequent step S323 may be performed.

In step S323, the elimination process is executed on the loop to delete all of the redundant memory access instructions in the loop.

In step S324, the elimination process is not executed on the loop. Optionally, all of the redundant memory access instructions are retained. In one possible implementation, when the ratio is less than the threshold, other elimination process is performed on the loop. This embodiment does not limit this.

According to this embodiment, it may determine whether the elimination process is performed on the redundant memory access instruction in the running loop according to the proportion of redundant memory access instructions in the loop. The process for eliminating the redundant memory access instruction may be more effectively optimized.

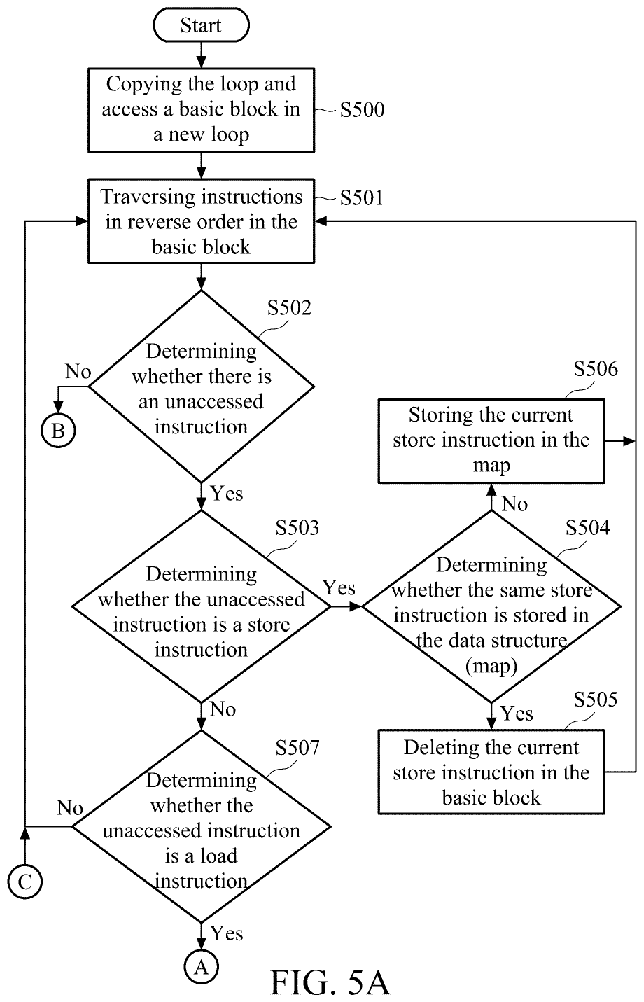

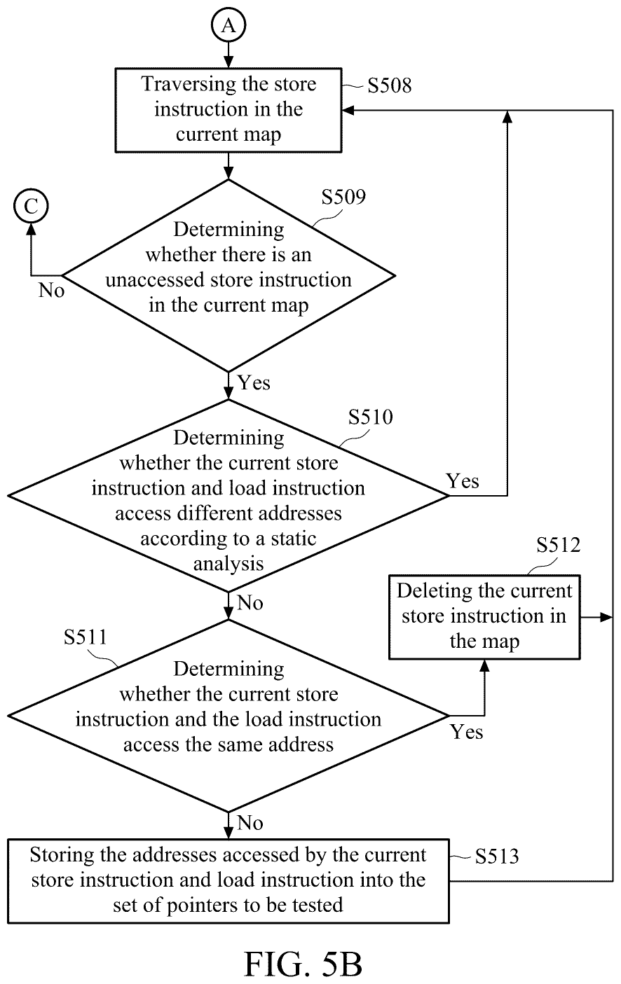

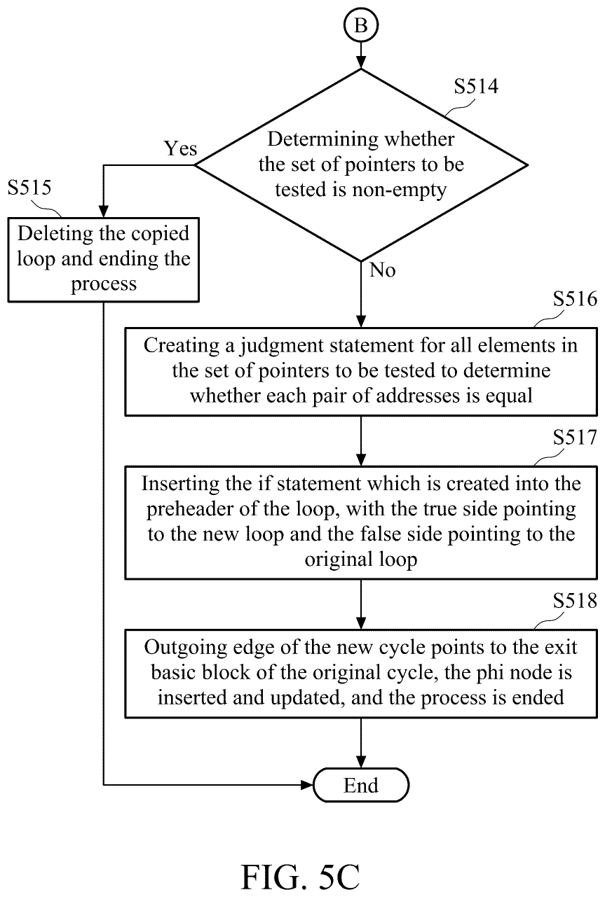

In order to understand easily, the command processing method of the present disclosure will be described below with FIGS. 5A-5C. Please refer to FIGS. 5A-5C, the instruction processing of the present disclosure may include the following steps:

Step S500 involves copying the loop and accessing a basic block in a new loop.

Step S501 involves traversing instructions in reverse order in the basic block.

Step S502 involves determining whether there is an unaccessed instruction. When it is determined that there is an unaccessed instruction, the subsequent step S503 is executed, otherwise, the subsequent step S514 is executed.

Step S503 involves determining whether the unaccessed instruction is a store instruction. When it is determined that the unaccessed instruction is a store instruction, the subsequent step S504 is executed, otherwise, the subsequent step S507 is executed.

Step S504 involves determining whether the same store instruction is stored in the data structure (map). When it is determined that the same store instruction is stored in the map, the subsequent step S505 is executed, otherwise, the subsequent step S506 is executed.

Step S505 involves deleting the current store instruction in the basic block, and then returning to continually execute step S501.

Step S506 involves storing the current store instruction in the map, and then returning to continually execute step S501.

Step S507 involves determining whether the unaccessed instruction is a load instruction. When it is determined that the unaccessed instruction is a load instruction, the subsequent step S508 is executed, otherwise, the subsequent step S501 is executed.

Step S508 involves traversing the store instruction in the current map.

Step S509 involves determining whether there is an unaccessed store instruction in the current map. When it is determined that there is an unaccessed store instruction in the current map, the subsequent step S510 is executed, otherwise, the subsequent step S501 is executed.

Step S510 involves determining whether the current store instruction and load instruction access different addresses according to a static analysis. When “yes” is determined, return to step S508, otherwise, execute the subsequent step S511.

Step S511 involves determining whether the current store instruction and the load instruction access the same address. When “yes” is determined, the subsequent step S512 is executed, otherwise, the subsequent step S513 is executed.

Step S512 involves deleting the current store instruction in the map, and then returning to step S508.

Step S513 involves storing the addresses (that is, load.addr and store.addr) accessed by the current store instruction and load instruction into the set of pointers to be tested, and then returning to step S508.

Through the above steps S501-S513, the set of pointers to be tested may be created for the loop of the program.

Step S514 involves determining whether the set of pointers to be tested is non-empty. When “yes” is determined, the subsequent step S515 is executed, otherwise, the subsequent step S516 is executed.

Step S515 involves deleting the copied loop and ending the process.

Step S516 involves creating a judgment statement (that is, an if statement) for all elements in the set of pointers to be tested to determine whether each pair of addresses is equal.

Step S517 involves inserting the if statement which is created into the preheader of the loop, with the true side pointing to the new loop and the false side pointing to the original loop.

In step S518 the outgoing edge of the new cycle points to the exit basic block of the original cycle, the phi node is inserted and updated, and the process is ended.

Through steps S514-S518 mentioned above, determining whether the set of pointers to be tested and created for the loop of the program is empty which may be used as the trigger condition for the elimination process of redundant memory access instructions.

FIG. 6 is a block diagram of a command processing method according to one embodiment of the present disclosure. In one possible implementation, the command processing device 600 may be applied to the compiler. In other words, the compiler may include the command processing device 600. Of course, it should be understood that the command processing device 600 may also be applied to other devices, that is, other devices may also include the command processing device 600. For the convenience of description, the following will take the compiler as an example. As shown in FIG. 6, the command processing device 600 may include the determination module 610 and the processing module 620. Wherein the determination module 610 is configured to determine whether the loop of the program running satisfies the predetermined condition for executing the elimination process to the redundant memory access instruction when the program is running. The processing module 620 is connected to the determination module 610. The processing module 620 is configured to execute the elimination process to the redundant memory access instruction in the loop when the determination module 610 is determined that the loop of the program running satisfies the predetermined condition.

In one possible implementation, the predetermined condition includes the set of pointers to be tested that were created for the loop of the program to record the pointer pair that have alias relationships not being empty. Correspondingly, the determination module 610 is configured to determine whether the set of pointers to be tested that were created for the loop of the program running is empty when the program is running. The processing module 620 is configured to execute the elimination process on the loop when the set of pointers to be tested that were created for the loop of the program is not empty.

In one possible implementation, the processing module 620 is configured to make a determination as to whether the set of pointers to be tested that were created for the loop of the program is not empty. If this is the case, then it determines whether the memory access instruction corresponding to the pointer pair has the redundant memory access instruction according to the instruction address corresponding to the pointer pair in the set of pointers to be tested. When it is determined that the memory access instruction corresponding to the pointer pair has the redundant memory access instruction, it deletes the redundant memory access instruction.

In one possible implementation, the processing module 620 is configured to: determine whether the instruction addresses corresponding to the pointer pair in the set of pointers to be tested are equal. When the instruction addresses corresponding to the pointer pair in the set of pointers to be tested are not equal, it determines that the memory access instruction corresponding to the pointer pair has the redundant memory access instruction.

In one possible implementation, the processing module 620 is configured to: in response to determining that the instruction addresses corresponding to the pointer pair in the set of pointers to be tested are equal, determine the memory access instruction corresponding to the pointer pair does not has the redundant memory access instruction; run the memory access instruction corresponding to the pointer pair and not execute the elimination process to the memory access instruction.

In one possible implementation, the processing module 620 is configured to make a determination as to whether the set of pointers to be tested that were created for the loop of the program is not empty, and if so, it determines whether the memory access instruction corresponding to the pointer pair has the redundant memory access instruction according to an instruction address corresponding to the pointer pair in the set of pointers to be tested. When it is determined that the memory access instruction corresponding to the pointer pair has the redundant memory access instruction, it counts the number of redundant memory access instructions and determines whether the elimination process on the loop is executed according to the number of redundant memory access instructions in the loop.

In one possible implementation, the processing module 620 is configured to calculate the ratio of the number of redundant memory access instructions in the loop to the total number of memory access instructions in the loop. When the ratio is greater than or equal to a threshold, the elimination process on the loop to delete all redundant memory access instructions in the loop is executed. Optionally, the threshold is a preset fixed value. For example, the threshold may be 10%. Optionally, the threshold may be dynamically adjusted.

In one possible implementation, when the ratio is less than the threshold, the processing module 620 is not executed the elimination process on the loop. Optionally, all redundant memory access instructions are retained in the loop. In one possible implementation, when the ratio is less than the threshold, the processing module 620 is configured to execute other elimination processing on the loop. This embodiment does not limit to this.

In one possible implementation, when it is determined that the loop of the program running does not satisfy the predetermined condition, the determination module 610 and the processing module 620 execute the processing again for the loop until the loop is executed a predetermined number of times.

In one possible implementation, when it is determined that the loop of the program running does not satisfy the predetermined condition, the determination module 610 and the processing module 620 run the loop and execute the processing sequentially for another loop of the program running.

In one possible implementation, the command processing device 600 further includes: a creating module (not shown in Figure). The creating module is configured to create a set of pointers to be tested for the loop of the program.

In one possible implementation, the creating module is configured to traverse instructions in reverse order in a basic block in the loop for the loop of the program. The creating module is configured to determine whether a first memory access instruction with the same address has been accessed before. When it is determined that the first memory access instruction with the same address has been accessed before and it cannot be determined whether an address of the second memory access instruction corresponding to the first memory access instruction between two of the first memory access instructions is the same address, the creating module is configured to record the address of the first memory access instruction and the address of the second memory access instruction into the set of pointers to be tested.

In one possible implementation, the redundant memory access instruction includes a read instruction, a write instruction, or both.

In some embodiments, the functions or modules included in the device provided by embodiments of the present disclosure may be configured to perform the methods described in the above method embodiments. For its specific implementation, reference may be made to the description of the above method embodiments. For the sake of simplicity, the details are not described here.

Embodiments of the present disclosure also provide a computer readable storage medium on which computer program instructions are stored. When the computer program instructions are executed by a processor, the above command processing method is implemented. The computer readable storage media may be volatile or non-volatile computer readable storage media.

Embodiments of the present disclosure also provide a command processing device. The command processing device includes a processor and a memory. The memory is configured to store a plurality of instructions, wherein the instructions are executed by the processor. The command processing method is implemented when the processor is configured to execute the instructions stored in the memory.

Embodiments of the present disclosure also provide a computer program product, including computer readable code, or a non-volatile computer readable storage medium carrying computer readable code. When the computer readable code is executed in the processor of the electronic device, the processor in the electronic device executes the above command processing method.

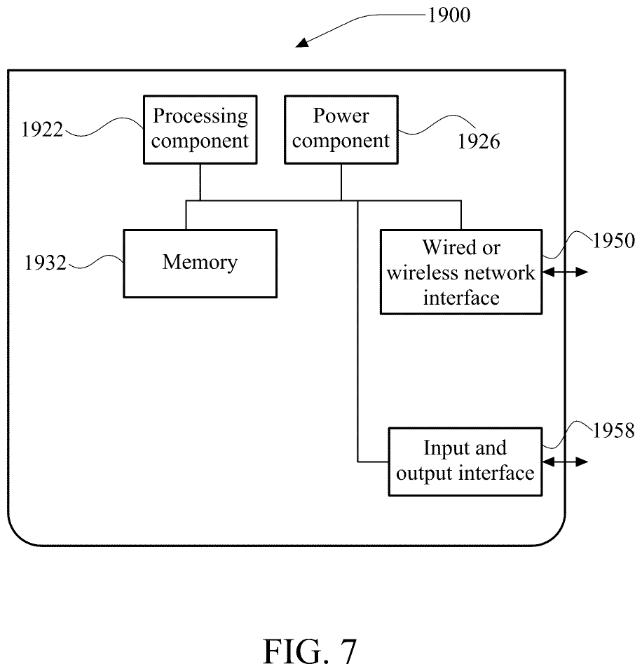

FIG. 7 is a block diagram of a command processing device 1900 according to one embodiment of the present disclosure. Refer to FIG. 7, the command processing device 1900 includes a processing component 1922 and a memory 1932. The processing component 1922 further includes one or more processors. The memory resource is represented by the memory 1932. The memory 1932 is configured to store instructions that may be executed by the processing component 1922, such as the application program. The application program stored in the memory 1932 may include one or more modules, each corresponding to a set of instructions. Additionally, the processing component 1922 is configured to execute instructions to execute the command processing method described above.

The command processing device 1900 further includes a power component 1926, a wired or wireless network interface 1950, and an input and output interface 1958 (I/O interface). The power component 1926 is configured to perform the power management of the device 1900. The wired or wireless network interface 1950 is configured to connect the device 1900 to the network. The device 1900 may operate based on the operating system stored in the memory 1932, such as Windows Server™, Mac OS X™, Unix™, Linux™, FreeBSD™ or the like.

In an exemplary embodiment, the non-volatile computer-readable storage medium is also provided, such as the memory 1932 including computer program instructions. The above-mentioned computer program instructions may be executed by the processing component 1922 of the device 1900 to complete the command processing method described above.

The present disclosure may be the system, the method, and/or the computer program product. The computer program product may include the computer-readable storage medium having thereon computer-readable program instructions for causing the processor to implement various aspects of the present disclosure.

The computer-readable storage medium may be the tangible device that may retain and store instructions for using by the instruction execution device. The computer-readable storage medium may be, for example, but not limited to, the electrical storage device, the magnetic storage device, the optical storage device, the electromagnetic storage device, the semiconductor storage device, or any suitable combination of the above. More specific examples (non-exhaustive list) of the computer-readable storage media include: the portable computer disks, the hard disks, the random access memory (RAM), the read-only memory (ROM), the erasable programmable read-only memory (EPROM or the flash memory), the static random access memory (SRAM), the portable compact disk read-only memory (CD-ROM), the digital versatile disk (DVD), the memory sticks, the floppy disks, the mechanical encoding devices such as punched cards or raised structure in groove on which instructions are stored, and the above any suitable combination. As used herein, the computer-readable storage media are not to be construed as transient signals per se, such as radio waves or other freely propagating electromagnetic waves, electromagnetic waves propagating through waveguides or other transmission media (e.g., light pulses through fiber optic cables), or electrical signals transmitted through wires.

The computer-readable program instructions described herein may be downloaded from the computer-readable storage medium to various computing/processing devices, or to the external computer or the external storage device through the network, such as the internet, the local area network, the wide area network, and/or the wireless network. The network may include the copper transmission cable, the fiber optic transmission, the wireless transmission, the router, the firewall, the switch, the gateway computer, and/or the edge server. The network adapter card or the network interface in each the computing/processing device receives the computer-readable program instructions from the network and forwards the computer-readable program instructions for storage in the computer-readable storage medium in each the computing/processing device.

The computer program instructions for performing operations of the present disclosure may be the assembly instructions, the instruction set architecture (ISA) instructions, the machine instructions, the machine related instructions, the microcode, the firmware instructions, the state setting data, or in one or more source code or object code written in any combination of programming languages. The programming languages described above include the object-oriented programming languages, such as Smalltalk, C++, etc., as well as conventional procedural programming languages, such as the “C” language or similar programming languages. The computer-readable program instructions may execute entirely on the user's computer, partly on the user's computer, as the stand-alone software package, partly on the user's computer and partly on the remote computer or entirely on the remote computer or the server implement. In situations involving remote computers, the remote computer may be connected to the user's computer through any kind of network including a local area network (LAN) or a wide area network (WAN)—or, it may be connected to an external computer (such as through an Internet service provider). In some embodiments, the electronic circuits, such as the programmable logic circuits, the field programmable gate arrays (FPGAs), or the programmable logic arrays (PLA), are customized by utilizing state information from the computer-readable program instructions. The electronic circuit may execute the computer-readable program instructions to implement various aspects of the disclosure.

Various aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams may be implemented by computer-readable program instructions.

These computer-readable program instructions may be provided to the processor of the general-purpose computer, the special-purpose computer, or other programmable data processing device, thereby producing a machine. These instructions produce means for implementing the functions/acts specified in one or more blocks of the flowcharts and/or the block diagrams when executed by the processor of the computer or the other programmable data processing device. These computer-readable program instructions may be stored in the computer-readable storage medium and cause the computer, the programmable data processing apparatus, and/or the other equipment to operate in a specific manner. Thus, the computer-readable medium storing instructions including an article of manufacture. The article of manufacture includes instructions for implementing various aspects of the functions/actions specified in one or more blocks of the flowcharts and/or block diagrams

The computer-readable program instructions may also be loaded onto a computer, other programmable data processing devices, or other equipment. The series of operating steps are performed on the computer, the other programmable data processing devices, or the other equipment to produce a computer-implemented process such that the computer, the other programmable data processing apparatus, or the other equipment performs the functions/acts specified in one or more blocks of the flowcharts and/or block diagrams.

The flowchart and block diagrams in the accompanying drawings illustrate the architecture, functionality, and operation of possible implementations of systems, methods, and computer program products according to various embodiments of the present disclosure. In this regard, each box in a flowchart or block diagram may represent portion of a module, a program segment, or an instruction. The portion of the module, the program segment or the instruction includes one or more executable instructions for implementing specified logical functions. In some alternative implementations, the functions noted in the block may occur out of the order noted in the figures. For example, two consecutive blocks may actually execute substantially in parallel, or they may sometimes execute in reverse order, depending on the functionality involved. It will also be noted that each block of the block diagram and/or flowchart illustration, and combinations of blocks in the block diagram and/or flowchart illustration, may be implemented by special purpose hardware-based systems that perform the specified functions or actions., or may be implemented using a combination of specialized hardware and computer instructions.

While the application has been described by way of example and in terms of the preferred embodiments, it should be understood that the application is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A command processing method, comprising:
executing a determination step to determine whether a loop of a program running satisfies a predetermined condition for executing an elimination process of a redundant memory access instruction when running the program; and
executing a processing step, wherein when it is determined that the loop of the program running satisfies the predetermined condition, the redundant memory access instruction in the loop is executed by the elimination process.

2. The command processing method as claimed in claim 1, wherein the predetermined condition comprises a set of pointers to be tested that were created for the loop of the program to record a pointer pair that have alias relationships not being empty;
wherein the determination step correspondingly comprises:
when the program is running, determining whether the set of pointers to be tested that were created for the loop of the program running is empty;
wherein the processing step correspondingly comprises:
when the set of pointers to be tested that were created for the loop of the program is not empty, executing the elimination process on the loop.

3. The command processing method as claimed in claim 2, wherein in response to determining that the set of pointers to be tested that were created for the loop of the program is not empty and the step of executing the elimination process on the loop comprises:
when the set of pointers to be tested that were created for the loop of the program is not empty, determining whether a memory access instruction corresponding to the pointer pair has the redundant memory access instruction according to an instruction address corresponding to the pointer pair in the set of pointers to be tested; and
when it is determined that the memory access instruction corresponding to the pointer pair has the redundant memory access instruction, deleting the redundant memory access instruction.

4. The command processing method as claimed in claim 3, wherein the step of determining whether the memory access instruction corresponding to the pointer pair has the redundant memory access instruction according to the instruction address corresponding to the pointer pair in the set of pointers to be tested comprises:
determining whether the instruction addresses corresponding to the pointer pair in the set of pointers to be tested are equal; and
when it is determined that the instruction addresses corresponding to the pointer pair in the set of pointers to be tested are not equal, determining the memory access instruction corresponding to the pointer pair has the redundant memory access instruction.

5. The command processing method as claimed in claim 4, further comprising:
when it is determined that the instruction addresses corresponding to the pointer pair in the set of pointers to be tested are equal, determining the memory access instruction corresponding to the pointer pair does not have the redundant memory access instruction; and
running the memory access instruction corresponding to the pointer pair and not executing the elimination process to the memory access instruction.

6. The command processing method as claimed in claim 2, wherein, when the set of pointers to be tested that were created for the loop of the program is not empty, the step of executing the elimination process on the loop comprises:
when the set of pointers to be tested that were created for the loop of the program is not empty, determining whether the memory access instruction corresponding to the pointer pair has the redundant memory access instruction according to an instruction address corresponding to the pointer pair in the set of pointers to be tested;
when it is determined that the memory access instruction corresponding to the pointer pair has the redundant memory access instruction, counting a number of redundant memory access instructions; and
determining whether the elimination process on the loop is executed according to the number of redundant memory access instructions in the loop.

7. The command processing method as claimed in claim 6, wherein the step of determining whether the elimination process on the loop is executed according to the number of redundant memory access instructions in the loop comprises:
calculating a ratio of the number of redundant memory access instructions in the loop to a total number of memory access instructions in the loop; and
when the ratio is greater than or equal to a threshold, executing the elimination process on the loop to delete all redundant memory access instructions in the loop.

8. The command processing method as claimed in claim 7, wherein, when the ratio is less than the threshold, the elimination process is not executed on the loop.

9. The command processing method as claimed in claim 6, wherein the step of determining whether the memory access instruction corresponding to the pointer pair has the redundant memory access instruction according to the instruction address corresponding to the pointer pair in the set of pointers to be tested comprises:
determining whether the instruction addresses corresponding to the pointer pair in the set of pointers to be tested are equal; and
when it is determined that the instruction addresses corresponding to the pointer pair in the set of pointers to be tested are not equal, determining the memory access instruction corresponding to the pointer pair has the redundant memory access instruction.

10. The command processing method as claimed in claim 1, further comprising:
when it is determined that the loop of the program running does not satisfy the predetermined condition, running the loop and executing the determination step and the processing step again for the loop until the loop is executed a predetermined number of times.

11. The command processing method as claimed in claim 1, further comprising:
when it is determined that the loop of the program running does not satisfy the predetermined condition, running the loop and executing the determination step and the processing step sequentially for another loop of the program running.

12. The command processing method as claimed in claim 2, wherein, before executing the determination step, the command processing method further comprises:
creating the set of pointers to be tested for the loop of the program.

13. The command processing method as claimed in claim 12, wherein the step of creating the set of pointers to be tested for the loop of the program comprises:
traversing instructions in reverse order in a basic block in the loop for the loop of the program;
determining whether a first memory access instruction with a same address has been accessed before; and
when it is determined that the first memory access instruction with the same address has been accessed before and it cannot be determined whether an address of the second memory access instruction corresponding to the first memory access instruction between two of the first memory access instructions is the same address, recording the address of the first memory access instruction and the address of the second memory access instruction into the set of pointers to be tested.

14. The command processing method as claimed in claim 1, wherein the redundant memory access instruction comprises at least one of a read instruction and a write instruction.

15. A command processing device, comprising:
a determination module, wherein the determination module is configured to determine whether a loop of a program running satisfies a predetermined condition for executing an elimination process of a redundant memory access instruction; and
a processing module, wherein when the determination module determines that the loop of the program running satisfies the predetermined condition, the processing module performs the elimination process on the redundant memory access instruction in the loop.

16. A command processing device, comprising:
a processor; and
a memory, configured to store a plurality of instructions, wherein the plurality of instructions are executed by the processor;
wherein the command processing method described in claim 1 is implemented when the processor is configured to execute the plurality of instructions stored in the memory.

17. A compiler, comprising the command processing device as claimed in claim 15.

18. A non-volatile computer readable storage media, wherein the non-volatile computer readable storage media stores computer program instructions; wherein when the computer program instructions are executed by a processor, the command processing method as claimed in claim 1 is implemented.

19. A computer program product, wherein the computer program product comprises computer program instructions; wherein when the computer program instructions are executed by one or more processors, the command processing method as claimed in claim 1 is implemented.
